(19) United States
(12) Patent Application Publication
(10) Pub. No.: US 2003/0110369 A1
(43) Pub. Date: Jun. 12, 2003

(54) Firmware extensions

(76) Inventors: Andrew J. Fish, Olympia, WA (US); Michael D. Kinney, Olympia, WA (US)

Correspondence Address: FISH & RICHARDSON, PC, 4350 LA JOLLA VILLAGE DRIVE, SUITE 500, SAN DIEGO, CA, 92122, US

(21) Appl. No.: 10/015,533

(22) Filed: Dec. 11, 2001

(51) Int. Cl. G06F 15/177

(52) U.S. Cl. 713/1

(57) ABSTRACT

Platform firmware capabilities may be extended during system boot by loading firmware extensions from a boot media before an operating system loader is loaded and run. The boot media may be a portion of a general purpose media such as a hard drive, a floppy disk, CD-ROM, or a DVD. A firmware extension, and the instructions and/or data to which the firmware extension enables access, represent a self-describing media module, which may be used to modularly extend platform firmware capabilities and to minimize non-volatile memory in a data processing system.

### REFERENCE TO COMPUTER PROGRAM LISTING APPENDIX

The present application is supplemented by a technical appendix submitted on compact disc in a file entitled “Intel_ExtensibleFirmwareInterface_Spec_V-1.02.txt” (created Dec. 11, 2001 and being 759,615 bytes in size (786,432 bytes used)), and this technical appendix is hereby incorporated by reference in its entirety.

### BACKGROUND

The present application describes systems and techniques relating to firmware extensions, for example, using self-describing media modules to minimize system nonvolatile random access memory (NVRAM) size.

Traditional firmware include machine instructions stored in non-volatile memory, which is typically read only memory (ROM) or flash memory. Thus, traditional firmware is a combination of software and hardware, although the term “firmware” is also used to refer to the software itself that is written with the intention of storing it in non-volatile memory. For example, on the Intel Architecture for Personal Computers (IA-PC), system firmware is commonly referred to as the BIOS (Basic Input/Output System), which is software alone.

A typical use for firmware is to provide machine instructions that control a data processing system when it is powered up from a shut down state, before volatile memory has been tested and configured. Firmware is also commonly used to reinitialize or reconfigure a data processing system after defined hardware events and/or to handle certain system level events like system interrupts.

The process of bringing a data processing system to its operating state from a powered down state is commonly known as bootstrapping, booting up, or the boot process. Bootstrapping typically begins with one or more processors in a data processing system. Each processor tests its internal components and interfaces. After the initial processor testing, initialization of system level resources commences. In multiprocessor systems, a single bootstrap processor (BSP) may be selected to handle initializing remaining processors and to handle the system level initialization. System level initialization typically includes procedures for checking memory integrity, identifying and initializing other resources in the data processing system, and loading an operating system (OS) into memory.

Loading an OS typically begins with loading a first stage OS loader from a specified location on a boot media. This first stage OS loader can then use basic hardware abstractions provided by the system firmware to load a more complex second stage OS loader. This process is continued until the OS is loaded and takes complete control of the data processing system.

Conventional firmware is typically written using a low level language (e.g., assembly language) that provides direct access to processor hardware. Thus, firmware is typically closely tied to the processor architecture of the system for which the firmware is designed. Due in part to the architecture-specific nature of the firmware, the underlying processor architecture is typically reflected in system level resources, which are initialized, configured and serviced by the firmware, in conventional data processing systems.

### DRAWING DESCRIPTIONS

FIG. 1 is a block diagram illustrating an example data processing system that uses firmware extensions to minimize system non-volatile memory size.

FIGS. 2A, 2B and 2C are block diagrams illustrating a system firmware interface specification that may be used with the example data processing system of FIG. 1 to provide a legacy free environment.

FIG. 3 is a block diagram illustrating an example boot media format using firmware extensions.

FIG. 4 is a logic flow diagram illustrating a boot sequence for a system using firmware extensions.

Details of one or more embodiments are set forth in the accompanying drawings and the description below. Other features and advantages may be apparent from the description and drawings, and from the claims.

### DETAILED DESCRIPTION

The systems and techniques described here relate to firmware extensions for use in reducing system nonvolatile memory in a data processing system/machine. As used herein, the term “firmware” means machine instructions for initializing a data processing system and loading an operating system (OS) upon power up. The term “platform” means hardware and firmware together on a data processing system. The term “platform firmware” means firmware that resides in a data processing system before power up (i.e., excluding firmware extensions). The term “system firmware” means firmware that resides in a data processing system after it has booted up and an operating system has been loaded (i.e., including firmware extensions).

Platform firmware capabilities may be extended during system boot by loading firmware extensions from a boot media before an operating system loader is loaded and run. The boot media may be a portion of a general purpose media such as a hard drive, a floppy disk, compact disc (CD), or digital versatile disc (DVD). For example, a system firmware interface specification may be used to define a block input/output protocol to abstract mass storage devices, thereby allowing boot services code to perform block input/output without knowing the type of a device or its controller.

A firmware extension, and the instructions and/or data to which the firmware extension enables access, represent a self-describing media module. Such self-describing media modules may be used to modularly extend platform firmware capabilities and to minimize non-volatile memory in a data processing system.

Firmware extensions may allow additional services to be added to system firmware without requiring additional non-volatile memory in the system. OEMs (Original Equipment Manufacturers) and/or OSVs (Operating System Vendors) may place firmware extensions on a boot media (e.g., a hard disk), thereby allowing software booted from the boot media to augment platform firmware capabilities. Firmware extensions may enable reduced system non-volatile memory (e.g., flash memory), thereby reducing system costs. In addition, firmware extensions may free up the OS loader from having to re-invent code that may basically exists in platform firmware in certain situations.

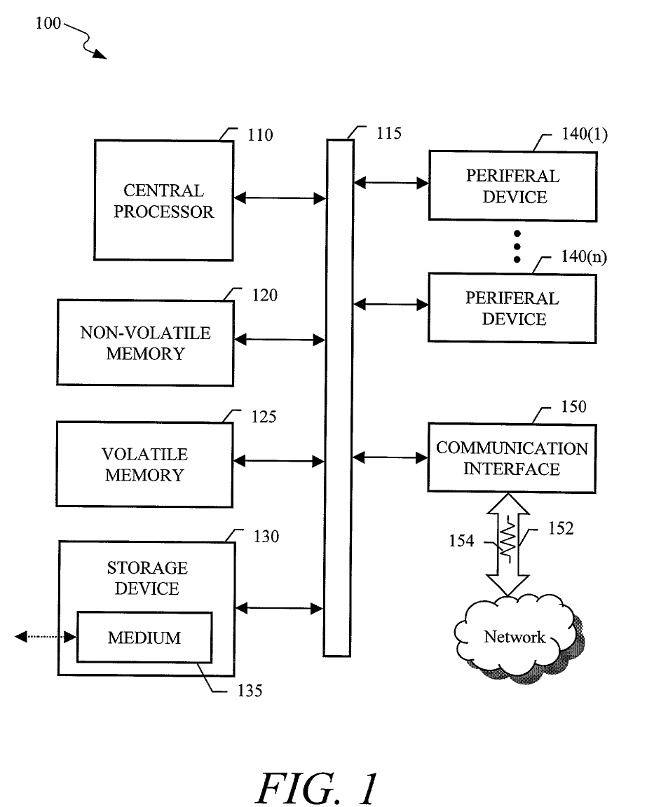

FIG. 1 is a block diagram illustrating an example data processing system 100 that uses firmware extensions to minimize system non-volatile memory size. The data processing system 100 includes a central processor 110, which executes programs, performs data manipulations and controls tasks in the system 100. The central processor 110 may include multiple processors or processing units and may be housed in a single chip (e.g., a microprocessor or microcontroller) or in multiple chips using one or more printed circuit boards or alternative inter-processor communication links (i.e., two or more discrete processors making up a multiple processor system). Examples of the processors and/or processing units that may be part of the central processor 110 include an arithmetic logic unit (ALU) to perform arithmetic and logic operations, a control unit to obtain and execute instructions, an auxiliary processor, a back-end processor, a digital signal processor, or a coprocessor.

The central processor 110 is coupled with a communication bus 115. The communication bus 115 provides one or more pathways through which data is transmitted among components of the system 100. The communication bus 115 may include multiple separate busses, each having an address bus and a data bus. For example, in a personal computer, the communication bus 115 represents an internal bus to connect internal components to the central processor 110 and memory, and an expansion bus to connect expansion boards and/or peripheral devices to the central processor 110. The communication bus 115 may include any known bus architecture (e.g., peripheral component interconnect (PCI), industry standard architecture (ISA), extended ISA (EISA)).

The data processing system 100 includes a nonvolatile memory 120 and a volatile memory 125, which are both coupled with the communications bus 115. The system 100 may also include one or more cache memories. These memory devices enable storage of instructions and data close to the central processor 110 for retrieval and execution.

The non-volatile memory 120 contains platform firmware (e.g., BIOS) to handle initialization of the data processing system 100 and loading of an operating system (OS) when starting up. Examples of the non-volatile memory 120 include NVRAM, ferroelectric random access memory (e.g., FRAM™), ferromagnetic random access memory (FM-RAM), read only memory (ROM), programmable read-only memory (PROM), erasable programmable read-only memory (EPROM), electrically erasable read-only memory (EEPROM), flash memory (block oriented memory similar to EEPROM), and the like.

The volatile memory, which requires a steady flow of electricity to maintain stored data, may be used to store instructions and data once the system 100 starts up. Examples of the volatile memory 125 include dynamic random access memory (DRAM), static random access memory (SRAM), synchronous dynamic random access memory (SDRAM), and Rambus® dynamic random access memory (RDRAM).

The data processing system 100 may include a storage device 130 for accessing a medium 135 (e.g., a boot media), which may be removable. The boot media may be a machine-readable medium that contains instructions and data (i.e., OS data) that are loaded into the volatile memory 125 when the system 100 boots up. The medium 135 may be read-only or read/write media and may be magnetic based or optical based media. Examples of the storage 130 and the medium 135 include a hard disk drive and hard disk platters, which may be removable, a floppy disk drive and floppy disk, a tape drive and tape, and an optical disc drive and optical disc (e.g., laser disk, CD-ROM (compact disc—read only memory), DVD).

The data processing system 100 may also include one or more peripheral devices 140(1)-140(n) (collectively, devices 140), and one or more controllers and/or adapters for providing interface functions. The devices 140 may be additional storage devices and media as described above, other storage interfaces and storage units, input devices or output devices. For example, the system 100 may include a display system having a display device (e.g., a video display adapter having components for driving a display (e.g., an LCD (liquid crystal display) or CRT (cathode ray tube) monitor), including video random access memory (VRAM), buffer, and graphics engine).

Additionally, the system 100 may include a serial port, parallel port, infrared port, universal asynchronous receiver-transmitter (UART) port, a PCMCIA (Personal Computer Memory Card International Association) slot, or printer adapter, for interfacing between various I/O devices such as a mouse, joystick, keyboard, trackball, trackpad, trackstick, PCMCIA card, printer, bar code reader, charge-coupled device (CCD) reader, scanner, video capture device, touch screen, stylus, transducer, microphone, speaker, etc.

The system 100 may further include a communication interface 150, which allows software and data to be transferred, in the form of signals 154, between the system 100 and external devices, networks or information sources. The signals 154 may be any signals (e.g., electronic, electromagnetic, optical) capable of being received via a channel 152 (e.g., wire, cable, optical fiber, phone line, infrared (IR) channel, radio frequency (RF) channel, etc.). The signals 154 may embody instructions for causing the system 100 to perform operations. For example, the signals 154 may embody instructions and data (representing a boot media (i.e., OS data)) that are loaded into the volatile memory 125 when the system 100 boots up, and that cause the system 100 to perform operations that support additional software applications on the system 100.

The communication interface 150 may be a communications port, a telephone modem or wireless modem. The communication interface 150 may be a network interface card (e.g., an Ethernet card) designed for a particular type of network, protocol and channel medium, or may be designed to serve multiple networks, protocols and/or channel media.

When viewed as a whole, the system 100 is a programmable machine. Example machines represented by the system 100 include a personal computer, a mobile system (e.g., a laptop or a personal digital assistant (PDA)), a workstation, a minicomputer, a server, a mainframe, and a supercomputer. The machine 100 may include various devices such as embedded controllers, Programmable Logic Devices (PLDs) (e.g., PROM (Programmable Read Only Memory), PLA (Programmable Logic Array), GAL/PAL (Generic Array Logic/Programmable Array Logic)), Field Programmable Gate Arrays (FPGAs), Application Specific Integrated Circuits (ASICs), single-chip computers, smart cards, and the like.

Machine instructions (also known as programs, software, software applications or code) may be stored in the machine 100 or delivered to the machine 100 over a communication interface. As used herein, the term “machine-readable material” refers to any machine-readable medium or device used to provide machine instructions and/or data to the machine 100. Examples of a machine-readable medium include the medium 135 and the like. Examples of a machine-readable device include the non-volatile memory 120, and/or PLDs, FPGAs, ASICs, and the like. The term “machine-readable signal” refers to any signal, such as the signals 154, used to provide machine instructions and/or data to the machine 100.

Other systems, architectures, and modifications and/or reconfigurations of machine 100 of FIG. 1 are also possible.

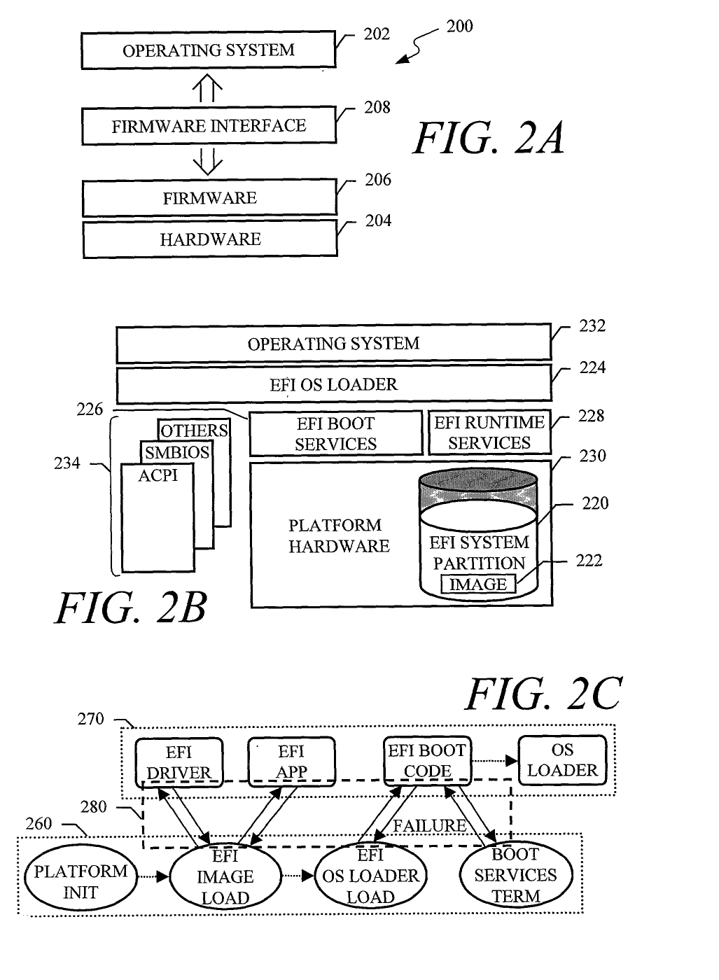

FIGS. 2A, 2B and 2C are block diagrams illustrating a system firmware interface specification that may be used with the example data processing system of FIG. 1 to provide a legacy free environment. As shown in FIG. 2A, a system 200 includes an OS 202, hardware 204 and firmware 206. A firmware interface specification 208 describes an interface between the OS 202 and the firmware 206. The interface 208 provides a standard interface that is not dependent on historic application program interfaces (APIs) (i.e., the interface 208 provides a legacy-free environment).

For example, the interface 208 may be in the form of data tables that contain platform-related information, and boot and runtime service calls that are available to the OS 202 and its loader. An example of the interface 208 is the Extensible Firmware Interface (EFI) architecture specification developed by Intel Corporation, located at 2080 Mission College Boulevard, Santa Clara Calif., 95052-8119. The EFI specification defines a set of interfaces and structures that platform firmware implements and that the OS may use in booting. The actual implementation of the firmware elements and how an OS uses the interfaces and structures is left undefined by EFI.

This is accomplished in EFI through a formal and complete abstract specification of the software-visible interface presented to the OS by the hardware and firmware. The EFI specification may be used with many data processing systems, including the next generation of IA-32 and Itanium™-based computers and data processing systems. The EFI specification provides a core set of services along with a selection of evolvable protocol interfaces to define an evolutionary path from the traditional style boot (e.g., a PC platform that uses the AT (advanced technologies) form factor for their motherboards) into a legacy-API free environment.

FIG. 2B is a block diagram illustrating interactions of various components of an EFI specification-compliant system that are used to accomplish platform and OS boot. The system includes platform hardware 230 and an OS 232. The platform firmware may retrieve an OS loader image 222 from an EFI System Partition 220 using an EFI OS loader 224.

The EFI System Partition 220 may be an architecturally shareable system partition. As such, the EFI System Partition 220 defines a partition and file system that are designed to allow safe sharing of mass storage between multiple vendors, including sharing for different purposes. The EFI specification defines persistent store on large mass storage media types for use by platform support code extensions to supplement the traditional approach of embedding code in the platform during manufacturing (e.g., in flash memory devices).

For example, a block input/output (I/O) protocol may be defined for use during boot services to abstract mass storage devices, thereby allowing boot services code to perform block I/O without knowing the type of a device or its controller. A variety of mass storage device types may be supported, including magnetic disks (e.g., floppy disk, hard disk) and optical disks (e.g., CD and DVD), as well as mass storage via a communication channel (i.e., remote boot via a network).

Once started, an OS loader continues to boot the complete OS 232, and in so doing, may use EFI boot services 226 and interfaces or other specifications to survey, comprehend and initialize the various platform components and the OS software that manages them. Thus, interfaces 234 from other specifications may also be present on the platform. For example, the Advanced Configuration and Power Interface (ACPI) (see http://acpi-info/index-html) and the System Management BIOS (SMBIOS) (see http://developer-intel-com/ial/WfM/design/BIBLIOG.HTM) from the Wired for Management (WfM) specification may be supported.

The EFI boot services 226 provide interfaces for devices and system functionality that can be used during boot time. Device access is abstracted through “handles” and “protocols.” EFI runtime services 228 may also be available to the OS loader during the boot phase. For example, a minimal set of runtime services may be presented to ensure appropriate abstraction of base platform hardware resources that may be needed by the OS 232 during its normal operations.

The Extensible Firmware Interface allows extension of platform firmware by loading EFI driver and EFI application images, which when loaded, have access to all EFI defined runtime and boot services. FIG. 2C is a block diagram illustrating a booting sequence for an EFI specification-compliant system. A boot manager 260 starts with a standard firmware platform initialization. Next, EFI drivers and applications are loaded iteratively from EFI binaries 270.

Then, the boot manager boots from an ordered list of EFI OS loaders using EFI boot code. If a failure occurs, a second boot option is selected, and so on. Once an EFI OS loader loads enough of its own environment to take control of the system's continued operation, boot services terminate.

EFI allows consolidation of boot menus from the OS loader and platform firmware into a single platform firmware menu. These platform firmware menus allow the selection of any EFI OS loader from any partition on any boot medium that is supported by EFI boot services. An EFI OS loader can support multiple options that can appear on the user interface. It is also possible to include legacy boot options, such as booting from the A: or C: drive in the platform firmware boot menus.

EFI supports booting from media that contain an EFI OS loader or an EFI-defined System Partition. An EFI-defined System Partition may be required by EFI to boot from a block device. EFI does not require any change to the first sector of a partition, so it is possible to build media that will boot on both legacy architectures (e.g., IA-PC) and EFI platforms.

The dashed arrows in FIG. 2C represent implementation aspects left undefined by the Extensible Firmware Interface. An EFI API 280 defines the interface between the boot manager 260 and the EFI binaries 270.

Version 1.02 of the EFI specification is available at http://developer-intel-com/technology/efi/main_specification.htm. Version 1.02 of the EFI specification is included in the technical appendix incorporated by reference herein.

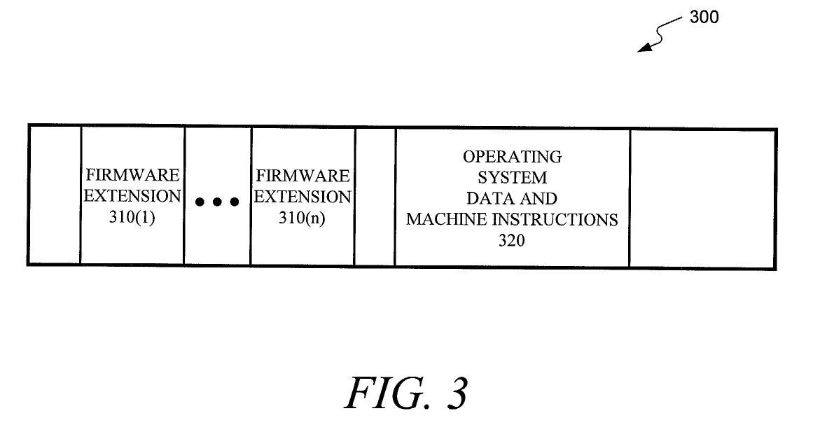

FIG. 3 is a block diagram illustrating an example boot media format using firmware extensions. A boot media 300 may be any machine-readable medium, including hard disk, floppy disk, CD, and DVD, or any type of boot device. The boot media 300 includes one or more firmware extensions 310(1) to 310(n) (collectively referred to as firmware extensions 310) and also includes operating system data and machine instructions 320.

The firmware extensions 310 allow additional services to be added to the firmware without requiring additional non-volatile memory in the system. In addition, the firmware extensions 310 may free up the OS loader from having to re-invent code that may basically exists in platform firmware in certain situations.

A firmware extension 310 may include an extension storing glyphs (fonts) on the boot media 300 for use in loading additional content. The platform firmware may have a display engine, but will unlikely be able to carry the thousands of glyphs required to represent all common languages (e.g., Japanese and Chinese). These glyphs may be stored on the boot media 300 and loaded dynamically by the platform firmware.

A firmware extension 310 also may include a file system driver to support a file system format not supported by the platform firmware. If the OS needs to read files from a file system, the boot media 300 may include a firmware extension 310 that provides a file system driver to access the file system on the boot media 300. Thus, media file systems may be changed and still support booting. For example, a future DVD format, which is not compatible with a CD file system (i.e., not ISO-9660 compatible), may be used on the boot media 300.

Additional firmware extensions 310 may include a Unicode collation module that may be used to do case insensitive compares and to determine the alphabetical order of characters for use in implementing a FAT (file allocation table) file system driver. The firmware extensions 310 may include any machine instructions that define operations that enable a data processing system to access additional machine instructions and data on a media, such as the operating system data and machine instructions 320.

A firmware extension, and the instructions and/or data to which the firmware extension enables access, represent a self-describing media module. Such self-describing media modules may be used to modularly extend platform firmware capabilities and to minimize non-volatile memory in a data processing system. For example, a motherboard in a computer may have flash memory storing platform firmware that implements a basic input/output system, which cannot read an entire media containing an OS because the OS uses an unknown format. But the basic input/output system can read a portion of the media, and this portion enables reading of the remainder of the media.

Thus, a general purpose media (i.e., a machine-readable medium having a general purpose such as booting an operating system or storing data) may be used to store firmware extensions on a first portion that provide machine instructions needed to access a second portion of the general purpose media. These machine instructions may be coded to an industry standard such that any vendor could extend the platform firmware capability.

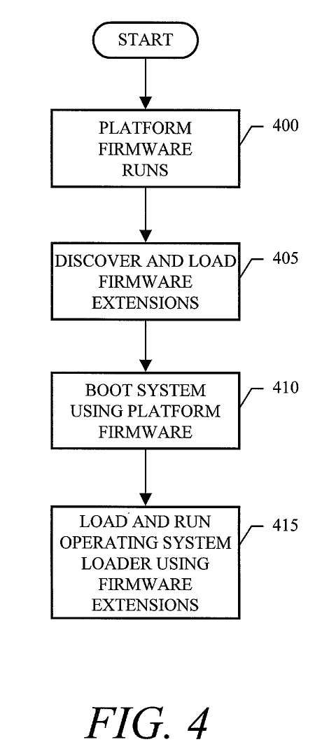

FIG. 4 is a logic flow diagram illustrating a boot sequence for a system using firmware extensions. The boot sequence begins when the system is turned on and the platform firmware runs (400). Then the platform firmware discovers any firmware extensions available on a boot media, or over a communication interface, and loads the firmware extensions (405).

Next, the system boots up using the platform firmware (410). Then, the platform firmware and firmware extensions load and run an OS loader.

The various implementations described above have been presented by way of example only, and not limitation. Other embodiments may be within the scope of the following claims.

What is claimed is:

1. A system comprising:
a central processor;
a non-volatile memory coupled with the central processor and storing platform firmware; and
a machine-readable medium coupled with the central processor, the machine-readable medium to be used in initializing an operating environment for the system upon power up, the machine-readable medium comprising a first set of instructions forming at least a portion of the operating environment, and a second set of instructions defining one or more firmware extensions to enable the system to access the first set of instructions.

2. The system of claim 1, wherein the machine-readable medium comprises a hard disk platter.

3. The system of claim 2, wherein the one or more firmware extensions comprise a file system driver to support a file system format not supported by the platform firmware.

4. The system of claim 1, wherein the non-volatile memory comprises random access non-volatile memory.

5. The system of claim 1, wherein the central processor comprises a central processing unit housed in a single chip.

6. The system of claim 5, further comprising:
a volatile memory; and
a motherboard coupling the volatile memory, the nonvolatile memory and the machine-readable medium with the central processing unit.

7. A machine-readable medium comprising:
a first set of instructions defining operations for enabling a machine to access a second set of instructions comprising at least a portion of an operating system stored on the machine-readable medium in a format that is unreadable by the machine before the machine loads the first set of instructions; and
the second set of instructions.

8. The machine-readable medium of claim 7, wherein the first set of instructions comprise one or more extensions to platform firmware capability.

9. The machine-readable medium of claim 8, wherein the portion of an operating system comprises an operating system loader.

10. The machine-readable medium of claim 9, wherein the one or more extensions to platform firmware capability comprise a file system driver to support a file system format used to store at least a portion of the second set of instructions.

11. The machine-readable medium of claim 9, wherein the one or more extensions to platform firmware capability comprise glyphs that represent a language.

12. The machine-readable medium of claim 9, wherein the one or more extensions to platform firmware capability comprise a Unicode collation module.

13. A machine-implemented method for extending platform firmware capabilities, the method comprising:
loading one or more firmware extensions from a boot media;
booting the system; and
loading and running an operating system loader from the boot media using the one or more loaded firmware extensions.

14. The machine-implemented method of claim 13, wherein loading one or more firmware extensions from a boot media during a system boot comprises using a block input/output protocol to abstract a mass storage device containing the boot media.

15. The machine-implemented method of claim 14, wherein the one or more firmware extensions comprise a file system driver to support a file system format used to store data on the boot media.

16. The machine-implemented method of claim 15, wherein the one or more firmware extensions further comprise glyphs that represent a language.

17. A data processing system comprising:
means for processing instructions and data;
non-volatile memory means for storing platform firmware; and
mass storage means providing means for extending platform firmware capabilities during system booting before an operating system loader is loaded and run.

18. The system of claim 17, wherein the mass storage means comprises an optical disk.

19. The system of claim 18, wherein the means for extending platform firmware capabilities comprise a file system driver to support a file system format not supported by the platform firmware.

20. The system of claim 19, wherein the non-volatile memory means comprises random access non-volatile memory.
